(19) United States
(12) Patent Application Publication
(10) Pub. No.: US 2026/0199855 A1
(43) Pub. Date: Jul. 16, 2026

(54) AGGLOMERATED FILLER FOR COMPOSITE MATERIALS

(71) Applicant: Lignetics, Inc., Broomfield, CO (US)

(72) Inventors: Frank Kvietok, Aurora, CO (US); Henry Wallace, Boulder, CO (US); Matthew Anderson, Deposit, NY (US)

(21) Appl. No.: 19/451,399

(22) Filed: Jan. 16, 2026

Related U.S. Application Data
(60) Provisional application No. 63/746,168, filed on Jan. 16, 2025.
(60) Provisional application No. 63/773,648, filed on Mar. 18, 2025.

(51) Int. Cl. B01J 2/22; C08J 3/20; C08J 3/22; C08L 97/02

(52) U.S. Cl. CPC B01J 2/22; C08J 3/203; C08J 3/22; C08L 97/02; C08J 2323/06; C08J 2497/02

(57) ABSTRACT

A filler concentrate may comprise: a solid polymer, comprising up to 10% of a weight of the filler concentrate; and a filler dispersed throughout the solid polymer and comprising at least 90% of the weight of the filler concentrate. A method of forming a wood pellet may comprise: introducing a solid polymer into a pellet mill in an amount of about 1-10 parts by weight; introducing a filler into the pellet mill in an amount of about 90-99 parts, by weight; mixing the solid polymer and the filler in the pellet mill, heat generated by mixing softening the solid polymer to enable bonding of the solid polymer to the filler; and extruding pellets including: the solid polymer comprising about 1%-10% of the weight of each pellet of the pellets; and the filler comprising about 90%-99% of the weight of each pellet.

### PRIORITY CLAIM

This application claims priority to U.S. Provisional Patent App. No. 63/746,168 filed on Jan. 16, 2025 and titled “AGGLOMERATED FILLER FOR COMPOSITE MATERIALS,” (the “'168 Provisional application”), and U.S. Provisional Patent App. No. 63/773,648 filed on Mar. 18, 2025 and titled “AGGLOMERATED FILLER FOR COMPOSITE MATERIALS,” (the “'648 Provisional application”). The '168 Provisional Application and the '648 Provisional Application are herein incorporated, in their entireties, by reference.

### TECHNICAL FIELD

This disclosure relates generally to fillers for composite materials and, more specifically, to filler concentrates that include particles of a filler and a solid polymer/binder that binds, or agglomerates, particles of the filler together. Even more specifically, this disclosure relates to wood flour pellets. This disclosure also relates to methods for forming agglomerates (e.g., pellets, granules, crumbles, etc.) of filler materials (e.g., wood flour, etc.) and to compounding methods that incorporate fillers from such concentrated filler agglomerates into polymers.

### RELATED ART

A variety of composite materials have been made by dispersing filler materials in polymers/binders. Fillers may be strategically selected to tailor the material's performance characteristics, such as strength, durability, thermal stability, and resistance to environmental factors. Composite materials also play a crucial role in advancing sustainability by incorporating recycled or reclaimed components. As an example, composite decking materials typically include polyethylene (PE) and/or polypropylene (PP), and reclaimed industrial wood residues.

The industrial wood residues used to make composite decking materials and other composite materials typically include relatively large pieces and particles, such as chips and sawdust. Compounders and plastic converters or plastic manufacturers have avoided using fillers with small particle sizes, such as wood flour, for a variety of reasons. For example, the low density of loose wood flour slows production rates to unacceptable levels.

Loose wood flour also creates an unacceptable mess and its airborne dust presents safety hazards (e.g., as a respiratory hazard, a combustibility hazard, etc.). In addition, loose wood flour has a propensity to absorb water, making it unsuitable for use in making composite decking materials since moisture evaporates into steam and causes foaming, which will decrease the strength of the resulting composite decking material. Addressing these challenges could enable the use of wood residual fillers, unlocking their benefits in composite production while maintaining manufacturing efficiency and product quality.

### SUMMARY

This disclosure, in various aspects, relates to agglomerates that enable the incorporation of fillers with small particle sizes into composite materials. Such an agglomerate, which may be referred to as a “filler concentrate,” may be in the form of a pellet, a granule, or a crumble.

In one aspect, a filler concentrate may include a solid polymer or another binder that holds particles of a filler together. The particles of filler may be dispersed throughout the solid polymer. Conversely, the solid polymer may be said to be dispersed throughout the particles of filler. The solid polymer may comprise up to about 10% of a weight of the filler concentrate, with the filler comprising at least about 90% of the weight of the filler concentrate. For example, the solid polymer may comprise 5% of the weight of the filler concentrate, with the filler comprising 95% of the weight of the filler concentrate. As another example, the solid polymer may comprise 2.5% of the weight of the filler concentrate, with the filler comprising 97.5% of the weight of the filler concentrate. In a further example the solid polymer may comprise as little as about 1% of the weight of the filler concentrate, with the filler comprising up to about 99% of the weight of the filler concentrate.

The solid polymer/binder may comprise a thermoplastic material or paraffin. The solid polymer/binder may have a melting point of 150° C. or less. Some examples of thermoplastic solid polymers with such a low melting point include polyethylene (PE) polymers, including but not limited to linear low density polyethylene (LLDPE). Other examples of solid polymers that may be included in a filler concentrate include a polyamide, an acrylic polymer, a polystyrene, a polypropylene (PP), an acrylonitrile butadiene styrene (ABS), polyglycolic acid, polyethylene glycol, a polycarbonate, polybenzimidazole, polyether sulfone, polyether ether ketone (PEEK), a polyetherimide, a polyphenylene oxide, a polyphenylene sulfide, a polyvinyl chloride, paraffin (a phase change hydrocarbon polymer), and polytetrafluoroethylene (PTFE), Fischer-Tropsch wax, polyethylene wax, biopolymers/waxes (such as polylactic acid, polyhydroxyalkanoate, Polybutylene Adipate Terephthalate, thermoplastic starch, rosin ester, rice bran wax, carnauba wax, and castor wax) as well as compatible combinations of any of the foregoing.

In embodiments where the solid polymer includes a plurality of different, immiscible polymers, the filler concentrate may optionally include one or more compatibilizers, coupling agents, interfacial adhesion promoters, or surface modifiers to increase the stability of the blend of polymers.

The filler may have a particle size of about 30 mesh (about 595 μm or about 0.0232 inch in diameter) to about 80 mesh (about 177 μm or about 0.007 inch in diameter). In some embodiments, the filler may have a particle size of about 10 mesh to about 250 mesh, or from about 20 mesh to about 100 mesh, or from about 40 mesh to about 80 mesh. The filler may comprise wood flour, consist essentially of wood flour (e.g., include some larger particles, contaminants, etc.), or consist of wood flour. Alternatively, the filler may comprise a carbonate, a silicate, talc, mica, wollastonite, clay, silica, alumina, carbon fiber, carbon black, a carbon nanotube, graphite, graphene, volcanic ash, expanded volcanic ash, perlite, glass fibers, solid glass microspheres, hollow glass microspheres, cenospheres, a ceramic, wood fibers, sawdust, wood shavings, newsprint, paper, flax, hemp, wheat straw, rice hulls, kenaf, jute, sisal, peanut shells, nut shells, coconut husks, soy hulls, and the like. The filler may also comprise a combination of any of the foregoing.

In another aspect, methods for forming agglomerates (e.g., pellets, granules, a crumble, etc.) of filler, or filler concentrates, are disclosed. Such a method may include use of an agglomerator (e.g., a pellet mill, etc.). A solid polymer and a filler may be introduced into the agglomerator and mixed by the agglomerator. In other configurations, mixing may occur prior to introduction into the agglomerator. Heat generated by the agglomerator may soften or melt the solid polymer, enabling it to bind to and agglomerate particles of the filler. In other configurations, the agglomerator or pellet mill may not generate heat to soften or melt the solid polymer.

The solid polymer may be introduced into the agglomerator in a particulate form. Without limitation, a powder, granules, or pellets of the solid polymer may be introduced into the agglomerator. The solid polymer may comprise one or more thermoplastic elastomers. Each thermoplastic elastomer may have a melting point of about 150° C. or less. Without limitation, the solid polymer may comprise a PE, such as an LLDPE.

The filler may have a particle size of about 30 mesh (about 595 μm or about 0.0232 inch in diameter) to about 80 mesh (about 177 μm or about 0.007 inch in diameter). Without limitation, the filler may include wood flour.

The solid polymer and the filler may be introduced into the agglomerator together (e.g., as a blend, as separate streams, etc.) or separately in desired proportions. As a few examples, about 1 part, by weight, to about 10 parts, by weight (e.g., about 1 part, 2.5 parts, 5 parts, about 10 parts, etc.), of the solid polymer may be introduced into the agglomerator, and about 90 parts, by weight, to about 99 parts, by weight (e.g., about 99 parts, 97.5 parts, 95 parts, about 90 parts, etc.), of the filler may be introduced into the agglomerator, with the combined solid polymer and filler comprising 100 parts or about 100 parts. Thus, the combined weight of the solid polymer and filler may comprise about 1% to about 10% of the solid polymer and about 90% to about 99% of the filler.

Optionally, where the solid polymer comprises a blend of solid polymers that are immiscible, one or more compatibilizers may be introduced into the agglomerator with the solid polymer and the filler.

As the agglomerator operates, it may generate sufficient heat to soften or melt the solid polymer and enable the softened or liquified polymer to bind particles of the filler to each other. Stated another way, by simply operating the agglomerator, sufficient heat may be generated to soften or melt the solid polymer to enable the solid polymer to agglomerate particles of the filler. Such agglomeration may occur without adding any further heat to the agglomerator.

The agglomerated blend of filler and polymer may be extruded. The agglomerated blend may be extruded as pellets, as granules, as a crumble, or as any other form of agglomerate.

Methods for forming composite material are also disclosed. A method for forming composite material may include mixing a thermoplastic elastomer and a filler concentrate of this disclosure to form a mixture. The thermoplastic elastomer may comprise a single type of thermoplastic elastomer, a blend of thermoplastic elastomers, or a blend of thermoplastic elastomers and one or more compatibilizers. Optionally, one or more compatibilizers may be mixed with the thermoplastic elastomer and the filler concentrate.

The mixture may be heated and mixing may continue until polymer from the filler concentrate has melted, pieces or particles of the thermoplastic elastomer have melted, and filler from the filler concentrate has dispersed throughout the thermoplastic elastomer to form a liquid composite blend. In some embodiments, the mixture may be heated to a first temperature (e.g., a melting point of the polymer of the filler concentrate, up to about 150° C., etc.) to melt the polymer of the filler concentrate, enabling particles of the filler of the filler concentrate to be dispersed throughout the polymer. The mixture may then be heated to a second temperature, which is greater than the first temperature, to melt the thermoplastic elastomer of the composite material. As the thermoplastic elastomer melts, the filler may be further dispersed throughout the thermoplastic elastomer, forming the liquid composite blend.

The liquid composite blend may then be formed into a desired shape. For example, the liquid composite blend may be extruded, molded, or formed into a desired shape by any other suitable process. Once in the desired shape, the composite blend may be allowed to cool or actively cooled to maintain the desired shape.

According to another aspect of this disclosure, the resulting composite material may include the thermoplastic elastomer, particles of the filler (which may have a particle size of about 30 mesh (about 595 μm or about 0.0232 inch in diameter) to about 80 mesh (about 177 μm or about 0.007 inch in diameter), and the polymer from the filler concentrate (e.g., an LLDPE, etc.), which has diffused into the thermoplastic elastomer of the composite material.

According to another aspect, a pellet may be formed that includes a filler of this disclosure. A filler rather than a filler concentrate refers to a composition that may include a wood flour, and an elastomer and/or thermoplastic and formed into a pellet such that the final pellet has a composition desired for a final product. The thermoplastic elastomer may comprise a single type of thermoplastic elastomer, a blend of thermoplastic elastomers, or a blend of thermoplastic elastomers and one or more compatibilizers. Optionally, one or more compatibilizers may be mixed with the thermoplastic elastomer and the filler concentrate. The final pellet comprised of the filler may be formed in an agglomerator (such as a pellet mill) according to this disclosure or other known methods. Other additives, including but not limited to, colorants, dyes, UV stabilizers, compatibilizers, fungicides, etc., may be added to the pellet.

According to another aspect, a composition may comprise a filler concentrate and one or more compatibilizers.

Other aspects of the disclosed subject matter, as well as features and advantages of various aspects of the disclosed subject matter, should become apparent to those of ordinary skill in the art through consideration of the ensuing description and the appended claims.

### BRIEF DESCRIPTION OF THE DRAWINGS

FIG. 1A shows an image depicting a pellet produced by using 1% PEG at 260 degrees Fahrenheit; and

FIG. 1B shows an image depicting a pellet produced by using 2.4% LLDPE at 220 degrees Fahrenheit.

### DETAILED DESCRIPTION

A method for forming an agglomerate (e.g., pellets, granules, a crumble, etc.) of filler, or a filler concentrate includes use of an agglomerator (e.g., a pellet mill, etc.). Any suitable type of agglomerator may be used. Without limitation, an agglomerator may include a pellet mill including a feeder, one or more dies, one or more rollers, a briquetting system, a disc agglomerator, a pin mill, etc. A solid polymer/binder and a filler may be introduced into the agglomerator and mixed by the agglomerator. Heat generated by operation of the agglomerator may soften or melt the solid polymer/binder, enabling it to bind to and agglomerate particles of the filler. In some embodiments, supplemental heat may be provided to heat the mixture.

The solid polymer/binder may be introduced into the agglomerator in a particulate form. Without limitation, a powder, granules, or pellets of the solid polymer/binder may be introduced into the agglomerator. The solid polymer/binder may comprise one or more thermoplastic elastomers. Each thermoplastic elastomer may have a melting point of about 150° C. or less. Without limitation, the solid polymer/binder may comprise a polyethylene (PE), such as an LLDPE, a polyamide, an acrylic polymer, a polystyrene, a polypropylene (PP), paraffin, an acrylonitrile butadiene styrene (ABS), polyglycolic acid, polyethylene glycol, a polycarbonate, polybenzimidazole, polyether sulfone, polyether ether ketone (PEEK), a polyetherimide, a polyphenylene oxide, a polyphenylene sulfide, a polyvinyl chloride, polytetrafluoroethylene (PTFE), Fischer-Tropsch wax, polyethylene wax, biopolymers/waxes (such as polylactic acid, polyhydroxyalkanoate, Polybutylene Adipate Terephthalate, thermoplastic starch, rosin ester, rice bran wax, carnauba wax, and castor wax), as well as compatible combinations of any of the foregoing.

The filler may have a particle size of about 30 mesh (about 595 μm or about 0.0232 inch in diameter) to about 80 mesh (about 177 μm or about 0.007 inch in diameter). Without limitation, the filler may comprise a mineral or organic filler such as biomass products, agricultural products, wood flour, a carbonate, a silicate, talc, mica, wollastonite, clay, silica, alumina, carbon fiber, carbon black, a carbon nanotube, graphite, graphene, volcanic ash, expanded volcanic ash, perlite, glass fibers, solid glass microspheres, hollow glass microspheres, cenospheres, a ceramic, wood fibers, sawdust, wood shavings, newsprint, paper, flax, hemp, wheat straw, rice hulls, kenaf, jute, sisal, peanut shells, soy hulls, coconut husks, nut shells, pyrolyzed materials such as char, and the like. The filler may also comprise a combination of any of the foregoing.

The solid polymer/binder and the filler may be introduced into the agglomerator together (e.g., as a blend, as separate streams, etc.) or separately in desired proportions. As a few examples, about 1 part, by weight, to about 10 parts, by weight (e.g., about 1 part, 2.5 parts, 5 parts, about 10 parts, etc.), of the solid polymer/binder may be introduced into the agglomerator, and about 90 parts, by weight, to about 99 parts, by weight (e.g., about 99 parts, 97.5 parts, 95 parts, about 90 parts, etc.), of the filler may be introduced into the agglomerator, with the combined solid polymer and filler comprising 100 parts or about 100 parts. Thus, the combined weight of the solid polymer and filler may comprise about 1% to about 10% of the solid polymer and about 90% to about 99% of the filler.

In other embodiments, solid polymer/binder and the filler may be introduced into the agglomerator together (e.g., as a blend, as separate streams, etc.) or separately in desired proportions. The proportions may be modified such that the final pellet has a composition that is the same as, or highly similar to, the composition of a desired final composite product (such as composite decking materials, construction materials, durable packaging materials, automotive components, housings for electronic devices, appliances, other articles of manufacture, other plastic articles of manufacture, etc.), or so the pellet acts as a masterbatch where the fillers and/or additives are let down to the ratio desired in the final composite product.

As a few examples, about 10 parts, by weight, to about 95 parts, by weight (e.g., about 10 parts, 40 parts, 80 parts, about 95 parts, etc.), of the solid polymer/binder may be introduced into the agglomerator, and about 5 parts, by weight, to about 90 parts, by weight (e.g., about 90 parts, 60 parts, 20 parts, about 5 parts, etc.), of the filler may be introduced into the agglomerator, with the combined solid polymer and filler comprising 100 parts or about 100 parts. Thus, the combined weight of the solid polymer and filler may comprise about 10% to about 95% of the solid polymer and about 5% to about 90% of the filler.

Optionally, where the solid polymer comprises a blend of solid polymers that are immiscible, one or more compatibilizers may be introduced into the agglomerator with the solid polymer and the filler.

As the agglomerator operates, it may generate sufficient heat to soften or melt the solid polymer and enable the softened or liquified polymer to bind particles of the filler to each other. Stated another way, by simply operating the agglomerator, sufficient heat may be generated to soften or melt the solid polymer to enable the solid polymer to agglomerate particles of the filler. Such agglomeration may occur without adding any further heat to the agglomerator. In some embodiments, however, supplemental heat may be applied to the mixture to soften or melt the solid polymer.

Regardless of whether the agglomerator is heated simply by its operation or by the application of supplemental heat while agglomerating the filler, agglomeration may occur at a temperature of 280° C. (536° F.) or less. When the filler comprises a wood flour, the agglomeration temperature may be low enough to prevent significant breakdown of lignin in the wood flour and, thus, to prevent particles of the wood flour from agglomerating more irreversibly, which might otherwise occur if the wood flour is heated to a temperature in a range of 280° C. to 450° C. (536° F. to 842° F.), depending on the type of wood type and heating conditions. Without limitation, wood flour can include any type of wood reduced to finely divided particles approximating those of cereal flours in size, appearance, and texture, including wood powder, wood mill, or any other type of small wood particles produced by any suitable means (via hammer mill, etc.). Wood flour may have any suitable particle size. Without limitation, wood flour may range in size from around 10 mesh to around 200 mesh or more. Typically, the moisture content of the wood flour is low. In some embodiments, a mixture of a single species may be used as desired, and in other embodiments, mixtures of two, three, four, or more species may be used as desired.

The agglomerated blend of filler and polymer may be extruded. The agglomerated blend may be extruded as pellets, as granules, as a crumble, or as any other form of agglomerate.

The following table shows the results of a study conducted to identify olymers that may be useful in agglomerating filler.

| | Composition | | | | | | |
|---|---|---|---|---|---|---|---|
| | HDPE (40% | | | | | | |
| | unless | | | | | | |
| | otherwise | | | | | | |
| | noted) + | | | | | | |
| | Agglomerated | | | | | | |
| | Filler | Flexural | | | | | |
| | (balance, | Strength | Flexural | Tensile | Tensile | | |
| | wood flour | at yield | modulus | strength | modulus | Impact | |
| | (WF)(60%, | (psi) | (psi) | (psi) | (psi) | strength | |
| | unless | break | stiffness | break | stiffness | (ft-lbs/in) | MFI |
| | otherwise | point in | in | point in | in | fracture | (g/10 min) |
| Sample | noted) | bending | bending | tension | tension | resistance | flowability |
| 1 | 100% HDPE | 3085 | 153933 | 3047 | 153260 | 0.3 | 0.39 |
| 2 | Loose flour | 5597 | 382037 | 3283 | 383741 | 0.07 | 0.26 |
| 3 | Pure WF | 5421 | 272180 | 3027 | 295738 | 0.09 | 0.12 |
| | 5% HYPOD | | | | | | |
| | polyolefin | | | | | | |
| 4 | dispersion | 5326 | 267856 | 2917 | 296972 | 0.06 | 0.16 |
| 5 | 7.5% HYPOD | 5557 | 266035 | 2990 | 247754 | 0.06 | 0.12 |
| 6 | 2.5% FT Wax | 5629 | 318320 | 3218 | 254645 | 0.07 | 0.21 |
| 7 | 5% FT Wax | 5551 | 309573 | 3135 | 243976 | 0.06 | 0.18 |
| 8 | 1% PEG | 4753 | 218259 | 2710 | 233954 | 0.08 | 0.22 |
| 9 | 5% LDPE | 5175 | 263855 | 3045 | 213949 | 0.07 | 0.2 |
| 10 | 10% LDPE | 5008 | 244536 | 2930 | 254291 | 0.08 | 0.31 |
| | CaCO3 Filler | 5660 | 268798 | 3454 | 309720 | | |

Avery small-scale pellet mill was used to process each composition, resulting in pellets or powder. The various compositions compounded differently from each other and some had unacceptably high melting temperatures. As the data above show, however, when pellets or other agglomerates of the various composite materials were injection molded (with a let-down ratio of 40% wood, by weight, 60% polymer, by weight), the resulting specimens had similar physical properties.

A subsequent study was conducted to evaluate polymers that would be useful in industrial scale agglomeration of fillers such as wood flour and other fillers with small particle sizes. Specifically, no polymer (i.e. pure wood flour), LLDPE (at 2.5%, 5%, and 10%), polyethylene glycol (PEG) (at 1% and 2%), and paraffin (at 2.5% and 5%) were used to agglomerate wood flour, each resulting in wood flour pellets.

Using an industrial-scale pellet mill, the wood flour and polymer were processed at a feed rate (i.e., feed screw rotation rate of 20 Hz), although feed rates of up to 40 Hz or more are also within the scope of this disclosure. Using a feed rate of 20 Hz, the following pelletization throughputs were achieved:

| Polymer | Throughput | Fines | |
|---|---|---|---|
| (balance, wood | (pellets only, | Collected | |
| flour) | tons/hr.) | (tons/hr.) | % Fines |
| 2.5% Paraffin | 0.90 | 0.049 | 5.16% |
| 2.4% LLDPE | 0.81 | 0.037 | 4.37% |
| 1% PEG | 0.68 | 0.050 | 6.87% |

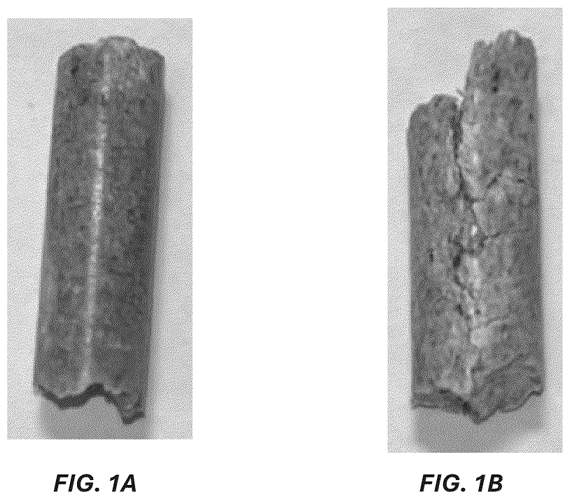

The filler that was agglomerated with paraffin formed crumbles, while the filler agglomerated with LLDPE and the filler agglomerated with PEG formed pellets. Notably, the pure wood flour pelletized without a polymer to bind particles of the wood flour together. FIG. 1A shows an image depicting a pellet produced by using 1% PEG at 260 degrees Fahrenheit, and FIG. 1B shows an image depicting a pellet produced by using 2.4% LLDPE at 220 degrees Fahrenheit.

The moisture content of the wood flour varied from 5.33% to 7.77%. As the wood flour was agglomerated, the moisture content decreased, with the moisture content of the resulting agglomerates (pellets, crumbles, etc.) ranging from 2.67% to 5.34%. The reduction in moisture content was most frequently between 2% and 2.5%. If the moisture content of the wood flour is maintained at 5% to 6%, the resulting agglomerate will have moisture content of about 2.5% to about 4%. The reduction in moisture content appears to correlate to the duration of time the agglomerate resides within the extrusion die of the pellet mill; the extrusion die may be heated during use of the pellet mill (e.g., to 220° F. (104.4° C.) when LLDPE is used, to 200° F. to 220° F. (93.3° C. to 104.4° C.) when PEG or paraffin is used, etc.).

In the agglomerated filler that results from such a process, the particles of filler may be dispersed throughout the solid polymer. The agglomerated filler may have a density that is about 3 times to about 4 times the density of loose filler, which may reduce or eliminate mess and hazards. Moreover, the agglomerated filler may be provided in a form that plastics composites industries (e.g., the composite decking industry, etc.) are familiar with and equipped to handle. Further, the amount of polymer included in the agglomerated filler may be small enough to have little or no impact on formulations for various composite materials, other than the replacement of currently used fillers with an agglomerated filler of this disclosure.

Additional runs were conducted to investigate optimal conditions, such as polymer type, polymer percentage by weight, and feed rate. Dependent variables were measured, such as power draw, pellet temperature, die temperature, pellet durability, moisture loss, passthrough, throughput, and fines.

Another method of forming a wood flour pellet may include forming a wood flour pellet in an agglomerator, the wood flour pellet having a final concentration identical or similar to a final product. The method may include: introducing a solid binder polymer into a an agglomerator, the agglomerator, comprising a die and rollers; introducing a filler into the agglomerator; mixing the solid binder and the filler in the agglomerator; and extruding pellets. The method may also include introducing an additive into the agglomerator, including but not limited to a colorant, a dye, a UV stabilizer, a compatibilizer, and a fungicide.

Another method of forming a wood flour pellet may include forming a wood flour pellet in a pellet mill, the wood flour pellet having a final concentration identical or similar to a final product. The method may include: introducing a solid binder polymer into a pellet mill, the pellet mill comprising a die and rollers; introducing a filler into the pellet mill; mixing the solid binder and the filler in the pellet mill; and extruding pellets. The method may also include introducing an additive into the pellet mill, including but not limited to a colorant, a dye, a UV stabilizer, a compatibilizer, and a fungicide.

A method for forming composite material may include mixing a suitable amount of a thermoplastic elastomer with a suitable amount of a filler concentrate of this disclosure. The thermoplastic elastomer may comprise a single type of thermoplastic elastomer, a blend of thermoplastic elastomers, or a blend of thermoplastic elastomers and one or more compatibilizers. For example, the thermoplastic elastomer may comprise PE, including recycled PE.

Optionally, one or more compatibilizers may be mixed with the thermoplastic elastomer and the filler concentrate. Without limitation, the one or more compatibilizers may comprise an anhydride-functionalized polymer such as Maleic Anhydride-grafted Polypropylene-epoxy (MAPP/E), Maleic Anhydride Grafted Polyethylene wax (MA-PE wax); or other materials such as silanes, isocyanates, as well as compatible combinations of any of the foregoing. The mixture may be heated to a suitable temperature and mixing may continue until polymer from the filler concentrate has melted, pieces or particles of the thermoplastic elastomer have melted, and filler from the filler concentrate has dispersed throughout the thermoplastic elastomer to form a liquid composite blend. As the polymer and thermoplastic elastomer melt, the filler may be dispersed throughout the thermoplastic elastomer, forming the liquid composite blend.

The liquid composite blend may then be formed into a desired shape. For example, the liquid composite blend may be extruded, molded, or formed into a desired shape by any other suitable process. Once in the desired shape, the composite blend may be allowed to cool or actively cooled to maintain the desired shape.

The resulting composite material may include the thermoplastic elastomer, particles of the filler (which may have a particle size of about 30 mesh (about 595 μm or about 0.0232 inch in diameter) to about 80 mesh (about 177 μm or about 0.007 inch in diameter)), and the polymer from the filler concentrate (e.g., an LLDPE, etc.), which has diffused into the thermoplastic elastomer of the composite material.

According to another aspect, a composition may comprise a filler and one or more compatibilizers. In such a composition, the compatibilizer may also be thought of as the binding agent rather than (or in addition to) a polymer. The filler may comprise any suitable filler material, such as wood flour. The filler may comprise wood flour, consist essentially of wood flour (e.g., include some larger particles, contaminants, etc.), or consist of wood flour. Alternatively, the filler may comprise a carbonate, a silicate, talc, mica, wollastonite, clay, silica, alumina, carbon fiber, carbon black, a carbon nanotube, graphite, graphene, volcanic ash, expanded volcanic ash, perlite, glass fibers, solid glass microspheres, hollow glass microspheres, cenospheres, a ceramic, wood fibers, sawdust, wood shavings, newsprint, paper, flax, hemp, wheat straw, rice hulls, kenaf, jute, sisal, peanut shells, nut shells, coconut husks, soy hulls, and the like. The filler may also comprise a combination of any of the foregoing. The composition may comprise the filler and one or more compatibilizers that are mixed with the filler. Mixing the filler with the compatibilizer (and optionally in the absence of thermoplastic elastomers) may allow the filler to mix with and form bonds with the compatibilizer.

According to a non-limiting example, a compatibilizer may be selected for its ability to chemically and physically bond filler material to polymer matrices (such as anhydride-functionalized polymers, silanes, isocyanates, etc). The compatibilizer may be applied to the filler at a range of about 1% to about 20% by weight of the compatibilizer within the composition to filler within the composition. For example, a composition may include about 1% to about 10% by weight MAPE added to about 90% to about 99% wood flour, mixed and extruded in an agglomerator where functional groups in MAPE form covalent ester bonds with hydroxyl groups in wood flour, while also enabling secondary interactions and physical interlocking for improved interfacial adhesion and resulting mechanical performance of the material in composites.

Such a filler-compatibilizer composition could be further processed, such as by being formed into a pellet.

An agglomerated filler, of a filler concentrate, of this disclosure may be used to manufacture any of a variety of composite materials used for any of a variety of different purposes. Some embodiments of the agglomerated filler may be used to make composite decking materials. Other embodiments of the agglomerated filler may be used to form other construction materials, durable packaging materials, automotive components, housings for electronic devices, appliances, single-use items such as cutlery and beverage accessories, other articles of manufacture, as well as a variety of other plastic articles of manufacture. In yet other embodiments, the agglomerated filler may have a final concentration similar or identical to the composite material to be manufactured.

Although this disclosure provides many specifics, these should not be construed as limiting the scope of any of the claims that follow, but merely as providing illustrations of some embodiments of elements and features of the disclosed subject matter. Other embodiments of the disclosed subject matter, and of their elements and features, may be devised which do not depart from the spirit or scope of any of the claims. Features from different embodiments may be employed in combination. Accordingly, the scope of each claim is limited only by its plain language and the legal equivalents thereto.

### EMBODIMENTS

Embodiment 1: A filler concentrate, comprising a solid polymer, comprising up to 10% of a weight of the filler concentrate; and a filler dispersed throughout the solid polymer and comprising at least 90% of the weight of the filler concentrate.
Embodiment 2: The filler concentrate of Embodiment 1, wherein the solid polymer has a melting point of 150° C. or less.
Embodiment 3: The filler concentrate of Embodiment 1 or 2, wherein the solid polymer comprises one or more of: a polyamide, an acrylic polymer, a polystyrene, a polypropylene (PP), a polyethylene, polyethylene glycol, acrylonitrile butadiene styrene (ABS), a polyglycolic acid, a polycarbonate, polybenzimidazole, polyether sulfone, a polyether ether ketone, a polyetherimide, a polyphenylene oxide, a polyphenylene sulfide, a polyvinyl chloride, and polytetrafluoroethylene.
Embodiment 4: The filler concentrate of any of Embodiments 1-3, wherein the solid polymer comprises a polyethylene (PE).
Embodiment 5: The filler concentrate of any of Embodiments 1-4, wherein the PE comprises a linear low density polyethylene (LLDPE).
Embodiment 6: The filler concentrate of Embodiment 1, wherein the filler comprises one or more of: wood flour, a carbonate, a silicate, talc, mica, wollastonite, clay, silica, alumina, carbon fiber, carbon black, a carbon nanotube, graphite, graphene, volcanic ash, expanded volcanic ash, perlite, glass fibers, solid glass microspheres, hollow glass microspheres, cenospheres, a ceramic, wood fibers, sawdust, wood shavings, newsprint, paper, flax, hemp, wheat straw, rice hulls, kenaf, jute, sisal, peanut shells, and soy hulls.
Embodiment 7: The filler concentrate of Embodiment 5, wherein the filler comprises a wood flour.
Embodiment 8: The filler concentrate of Embodiment 7, wherein the wood flour has a particle size of about 10 mesh to about 250 mesh, from about 20 mesh to about 100 mesh, or from about 40 mesh to about 80 mesh.
Embodiment 9: The filler concentrate of Embodiment 7, wherein the LLDPE comprises about 5% of the weight of the filler concentrate; and the wood flour comprises about 95% of the weight of the filler concentrate.
Embodiment 10: The filler concentrate of Embodiment 7, wherein the LLDPE comprises about 2.5% of the weight of the filler concentrate; and the wood flour comprises about 97.5% of the weight of the filler concentrate.
Embodiment 11: The filler concentrate of Embodiment 7, comprising pellets of the LLDPE and the wood flour.
Embodiment 12: The filler concentrate of Embodiment 1, wherein the filler concentrate comprises one or more of pellets, granules, agglomerates, and crumbles thereof.
Embodiment 13: The filler concentrate of Embodiment 1, wherein the filler concentrate includes one or more compatibilizers.
Embodiment 14: A method of forming a wood flour pellet, comprising introducing a solid binder into a pellet mill in an amount of about 1 part, by weight, to about 10 parts, by weight; introducing a filler into the pellet mill in an amount of about 90 parts, by weight, to about 99 parts, by weight; mixing the solid binder and the filler in the pellet mill, such that heat generated by mixing softens or melts the solid binder to enable the solid binder to bond to the filler; and extruding pellets including the solid binder comprising about 1% to about 10% of the weight of each pellet of the pellets; and the filler comprising about 90% to about 99% of the weight of each pellet.
Embodiment 15: The method of Embodiment 14, wherein the method consists essentially of introducing the solid binder into the pellet mill, introducing the filler into the pellet mill, mixing the solid binder and the filler in the pellet mill, and extruding the pellets.
Embodiment 16: The method of Embodiment 14, wherein introducing the filler into the pellet mill comprises introducing a filler comprising a wood flour into the pellet mill.
Embodiment 17: The method of Embodiment 16, wherein introducing the filler into the pellet mill comprises introducing a filler consisting essentially of a wood flour into the pellet mill.
Embodiment 18: The method of Embodiment 14, wherein introducing the solid binder into the pellet mill comprises introducing a solid binder with a melting point of 150° C. or less into the pellet mill.
Embodiment 19: The method of Embodiment 18, wherein introducing the solid binder with the melting point of 150° C. or less into the pellet mill comprises introducing a solid polymer into the pellet mill.
Embodiment 20: The method of Embodiment 19, wherein introducing the solid polymer into the pellet mill comprises introducing a linear low-density polyethylene (LLDPE) into the pellet mill.
Embodiment 21: A method for forming a composite material, comprising mixing a thermoplastic elastomer and solid pieces of a filler concentrate to form a mixture, the filler concentrate comprising a solid polymer; and a filler; heating the mixture to at least partially melt the solid polymer to release the particles of the filler from the solid pieces of the filler concentrate; and melt the thermoplastic elastomer to enable the particles of the filler to diffuse throughout the thermoplastic elastomer to form a liquid composite blend; forming the liquid composite blend into a desired shape; and cooling the liquid composite blend to form the composite material in the desired shape.
Embodiment 22: The method of Embodiment 21, wherein mixing the thermoplastic elastomer and the solid pieces of the filler concentrate comprises mixing the thermoplastic elastomer with pellets of the filler concentrate.
Embodiment 23: The method of Embodiment 21, wherein mixing the thermoplastic elastomer and solid pieces of the filler concentrate comprises mixing the thermoplastic elastomer with solid pieces of a filler concentrate in which the filler comprises a wood flour.
Embodiment 24: The method of Embodiment 21, wherein mixing the thermoplastic elastomer and solid pieces of the filler concentrate comprises mixing the thermoplastic elastomer with solid pieces of a filler concentrate in which the filler consists essentially of a wood flour.
Embodiment 25: The method of Embodiment 21, wherein heating the mixture includes heating the mixture to a first temperature that melts the solid polymer; and heating the mixture to a second temperature that exceeds the first temperature to melt the thermoplastic elastomer.
Embodiment 26: The method of Embodiment 25, wherein forming the liquid composite blend into the desired shape comprises extruding the liquid composite blend.
Embodiment 27: The method of Embodiment 25, wherein forming the liquid composite blend into the desired shape comprises molding the liquid composite blend.
Embodiment 28: A composite material, comprising a thermoplastic elastomer; particles of a filler material dispersed throughout the thermoplastic elastomer; and a solid polymer that bound the particles of the filler material diffused into the thermoplastic elastomer.
Embodiment 29: The composite material of Embodiment 28, wherein the particles of filler material comprise particles of about 10 mesh to about 250 mesh, from about 20 mesh to about 100 mesh, from about 40 mesh to about 80 mesh, or from about 30 mesh to about 70 mesh in size.
Embodiment 30: The composite material of Embodiment 28, wherein the particles of filler material comprises a wood flour.
Embodiment 31: The composite material of Embodiment 28, further comprising an additive.
Embodiment 32: The composite material of Embodiment 31, wherein the additive comprises one or more of a copolymer, a UV stabilizer, and an antibacterial.
Embodiment 33: A filler concentrate, comprising a solid thermoplastic, comprising up to 10% of a weight of the filler concentrate; and a filler dispersed throughout the solid thermoplastic, and comprising at least 90% of the weight of the filler concentrate.
Embodiment 34: A method of forming an agglomerate, comprising introducing a solid polymer into an agglomerator in an amount of about 1 part, by weight, to about 10 parts, by weight; introducing a filler into the agglomerator in an amount of about 90 parts, by weight, to about 99 parts, by weight; mixing the solid polymer and the filler in the agglomerator, heat generated by mixing softening the solid polymer to enable the solid polymer to bond to the filler; and forming the agglomerates including the solid polymer comprising about 1% to about 10% of the weight of each agglomerate; and the filler comprising about 90% to about 99% of the weight of each agglomerate.
Embodiment 35: The method of Embodiment 34, further comprising adding a compatibilizer.
Embodiment 36: A method of forming a wood flour pellet, comprising introducing a solid binder polymer into a pellet mill, the pellet mill comprising a die and rollers; introducing a filler into the pellet mill; mixing the solid binder and the filler in the pellet mill; and extruding pellets.
Embodiment 37: The method of Embodiment 36, further comprising introducing an additive into the pellet mill.
Embodiment 38: The method of Embodiment 37, wherein the additive comprises one or more of a colorant, a dye, a UV stabilizer, a compatibilizer, and a fungicide.
Embodiment 40: A composition, the composition comprising filler and a compatibilizer, the compatibilizer dispersed throughout the filler and comprising from about 1% to about 20% by of the weight of the composition.
Embodiment 41: The composition of Embodiment 40, wherein the filler concentrate comprises wood flour and a compatibilizer, which is selected from the group of one or more of: Anhydride-functionalized polymers, such as Maleic Anhydride-grafted Polypropylene-epoxy (MAPP/E), Maleic Anhydride Grafted Polyethylene wax (MA-PE wax), or other materials such as silanes, and isocyanates.

A filler concentrate for use in thermoplastic composite manufacture, comprising: lignocellulosic plant material, the lignocellulosic plant material comprising at least about 90% by weight of the pelletized filler concentrate; a binding material that chemically and physically bonds the lignocellulosic plant material to thermoplastic polymer matrices; and a solid polymer binder, the solid polymer binder has a melting point of 150° C. or less and comprises up to about 10% by weight of the pelletized filler concentrate; wherein the binding material is selected from maleic-anhydride-grafted polypropylene, maleic-anhydride-grafted polyethylene, maleated polyethylene waxes, silane coupling agents, and isocyanates; the binding material is present in an amount of about 1% to about 20% by weight based on the weight of the lignocellulosic plant material; the binding material comprises reactive functional groups selected from anhydride, carboxylic acid, epoxy, isocyanate, and alkoxysilane groups configured to react with hydroxyl groups on the lignocellulosic plant material to form covalent bonds including ester, urethane, and siloxane linkages, while also promoting secondary interactions and physical interlocking between the lignocellulosic plant material and the thermoplastic polymer matrices.

What is claimed:

1. A filler concentrate, comprising:
a solid polymer, comprising up to 10% of a weight of the filler concentrate; and
a filler dispersed throughout the solid polymer and comprising at least 90% of the weight of the filler concentrate.

2. The filler concentrate of claim 1, wherein the solid polymer has a melting point of 150° C. or less.

3. The filler concentrate of claim 1, wherein the solid polymer comprises one or more of: a polyamide, an acrylic polymer, a polystyrene, a polypropylene (PP), a polyethylene, polyethylene glycol, acrylonitrile butadiene styrene (ABS), a polyglycolic acid, a polycarbonate, polybenzimidazole, polyether sulfone, a polyether ether ketone, a polyetherimide, a polyphenylene oxide, a polyphenylene sulfide, a polyvinyl chloride, and polytetrafluoroethylene.

4. The filler concentrate of claim 3, wherein the solid polymer comprises a polyethylene (PE).

5. The filler concentrate of claim 4, wherein the PE comprises a linear low density polyethylene (LLDPE).

6. The filler concentrate of claim 1, wherein the filler comprises one or more of: wood flour, a carbonate, a silicate, talc, mica, wollastonite, clay, silica, alumina, carbon fiber, carbon black, a carbon nanotube, graphite, graphene, volcanic ash, expanded volcanic ash, perlite, glass fibers, solid glass microspheres, hollow glass microspheres, cenospheres, a ceramic, wood fibers, sawdust, wood shavings, newsprint, paper, flax, hemp, wheat straw, rice hulls, kenaf, jute, sisal, peanut shells, and soy hulls.

7. The filler concentrate of claim 5, wherein the filler comprises wood flour.

8. The filler concentrate of claim 7, wherein the wood flour has a particle size of about 10 mesh to about 250 mesh, from about 20 mesh to about 100 mesh, or from about 40 mesh to about 80 mesh.

9. The filler concentrate of claim 7, wherein:
the LLDPE comprises about 5% of the weight of the filler concentrate; and
the wood flour comprises about 95% of the weight of the filler concentrate.

10. The filler concentrate of claim 7, wherein:
the LLDPE comprises about 2.5% of the weight of the filler concentrate; and
the wood flour comprises about 97.5% of the weight of the filler concentrate.

11. The filler concentrate of claim 7, comprising pellets of the LLDPE and the wood flour.

12. The filler concentrate of claim 1, wherein the filler concentrate comprises one or more of pellets, granules, agglomerates, and crumbles thereof.

13. The filler concentrate of claim 1, wherein the filler concentrate includes one or more compatibilizers.

14. A composite material, comprising:
a thermoplastic elastomer;
particles of a filler material dispersed throughout the thermoplastic elastomer; and
a solid polymer that binds the particles of the filler material diffused into the thermoplastic elastomer.

15. The composite material of claim 14, wherein the particles of filler material comprise particles of about 10 mesh to about 250 mesh, from about 20 mesh to about 100 mesh, from about 40 mesh to about 80 mesh, or from about 30 mesh to about 70 mesh in size.

16. The composite material of claim 14, wherein the particles of filler material comprise a wood flour.

17. The composite material of claim 14, further comprising an additive.

18. The composite material of claim 17, wherein the additive comprises one or more of a copolymer, a UV stabilizer, and an antibacterial.

19. A composition, the composition comprising:
filler and a compatibilizer, the compatibilizer dispersed throughout the filler and comprising from about 1% to about 20% by weight of the composition.

20. The composition of claim 19, wherein the filler comprises wood flour and the compatibilizer is selected from the group consisting of: Anhydride-functionalized polymers, such as Maleic Anhydride-grafted Polypropylene-epoxy (MAPP/E), Maleic Anhydride Grafted Polyethylene wax (MA-PE wax), or other materials such as silanes, and isocyanates.
